(19) United States
(12) Patent Application Publication
(10) Pub. No.: US 2021/0281525 A1
(43) Pub. Date: Sep. 9, 2021

(54) GATEWAY DEVICE

(71) Applicant: MING-TSUNG CHEN, Taipei City (TW)

(72) Inventor: MING-TSUNG CHEN, Taipei City (TW)

(21) Appl. No.: 16/810,227

(22) Filed: Mar. 5, 2020

(51) Int. Cl. H04L 12/947; H04L 12/66; H04W 4/80

(52) U.S. Cl. CPC H04L 49/25; H04W 88/16; H04W 4/80; H04L 12/66

(57) ABSTRACT

A gateway device includes a multifunction wireless communication module, an edge-computing module, a control module, and a wired communication module. The multifunction wireless communication module includes a long-distance communication unit and a first short-distance communication unit. Signals needed to be immediately computed by the edge-computing module of the long-distance communication signals of the long-distance communication unit and the short-distance communication signals of the first short-distance communication unit are directly transmitted to the edge-computing module through communication paths. Communication protocols of the signals transmitted to the edge-computing module are not changed. The long-distance communication signals and the short-distance communication signals computed by the edge-computing module are transmitted to the long-distance communication unit and the first short-distance communication unit for communication.

### FIELD OF THE DISCLOSURE

The present disclosure relates to a gateway device, and more particularly to a gateway device being capable of adjusting connection capacity based on a loading thereof.

### BACKGROUND OF THE DISCLOSURE

A connection capacity of a gateway device in most situations is determined when the gateway device is designed. In the case where adaptation to various environments or working states is required, multiple gateway devices can be used. However, the cost of the gateway devices would be accordingly increased.

Therefore, providing a gateway device that can adjust the connection capacity based on the working state has become an important issue in the industry.

### SUMMARY OF THE DISCLOSURE

In response to the above-referenced technical inadequacies, the present disclosure provides a gateway device. The gateway device includes a multifunction wireless communication module, an edge-computing module, a control module, and a wired communication module.

The multifunction wireless communication module includes a long-distance communication unit and a first short-distance communication unit. The long-distance communication unit is electrically connected to a long-distance communication antenna. The long-distance communication unit transmits or receives a plurality of long-distance communication signals having a first communication protocol. The first short-distance communication unit is electrically connected to the long-distance communication unit and a first short-distance communication antenna. The first short-distance communication unit transmits or receives a plurality of short-distance communication signals having a second communication protocol through the first short-distance communication antenna. The long-distance communication unit and the first short-distance communication unit respectively include a protocol coding table. When the long-distance communication signals received by the long-distance communication unit are transmitted to the first short-distance communication unit, the first short-distance communication unit converts the long-distance communication signals having the first communication protocol into the short-distance communication signals having the second communication protocol according to the protocol coding table. When the short-distance communication signals received by the first short-distance communication unit are transmitted to the long-distance communication unit, the long-distance communication unit converts the short-distance communication signals having the second communication protocol into the long-distance communication signals having the first communication protocol according to the protocol coding table. The protocol coding table is a coding table between the first communication protocol and the second communication protocol. The edge-computing module is electrically connected to the multifunction wireless communication module. Signals needed to be immediately computed by the edge-computing module of the long-distance communication signals of the long-distance communication unit and the short-distance communication signals of the first short-distance communication unit are directly transmitted to the edge-computing module through communication paths. Communication protocols of the signals transmitted to the edge-computing module are not changed. The long-distance communication signals and the short-distance communication signals computed by the edge-computing module are transmitted to the long-distance communication unit and the first short-distance communication unit for communication. The control module is electrically connected to the multifunction wireless communication module. The wired communication module is electrically connected to the control module. The wired communication module receives a plurality of wired communication signals. The wired communication signals are wirelessly transmitted by the long-distance communication unit or the first short-distance communication unit of the multifunction wireless communication module.

Therefore, the gateway device of the present disclosure can convert the communication protocol by the long-distance communication unit and the short-distance communication units in the multifunction wireless communication module, which greatly reduces a workload of the control module. In addition, the gateway device of the present disclosure can also adjust the connection capacity by turning on or turning off the short-distance communication units, which greatly improves the adaptability for various working states.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a gateway device according to an embodiment of the present disclosure.

FIG. 2 is a schematic view of a multifunction wireless communication module of the present disclosure.

FIG. 3 is schematic view showing the multifunction wireless communication module communicating with an edge-computing module.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

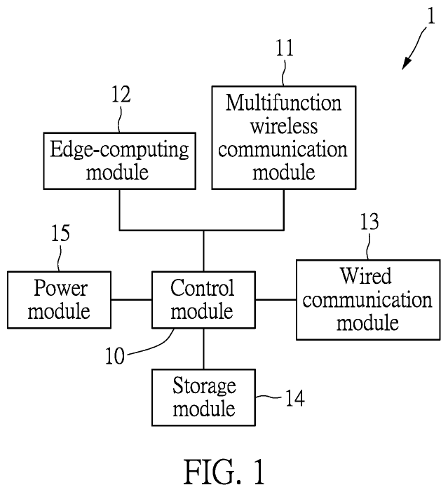

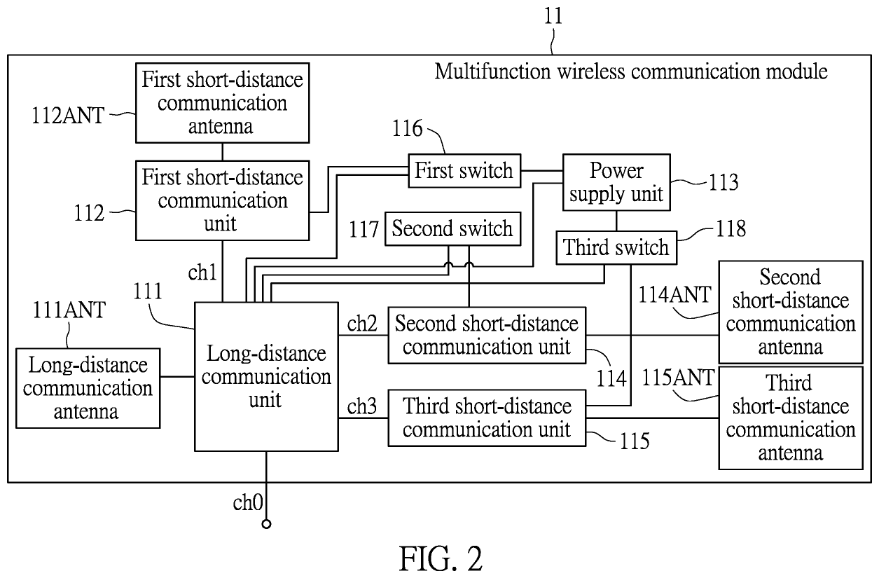

Referring to FIG. 1 and FIG. 2, FIG. 1 is a schematic view of a gateway device according to an embodiment of the present disclosure. FIG. 2 is a schematic view of a multifunction wireless communication module of the present disclosure.

A gateway device 1 includes a control module 10, a multifunction wireless communication module 11, an edge-computing module 12, a wired communication module 13, a storage module 14, and a power module 15.

The control module 10 is electrically connected to the multifunction wireless communication module 11, the edge-computing module 12, the wired communication module 13, the storage module 14, and the power module 15. The multifunction wireless communication module 11 is electrically connected to the edge-computing module 12.

The control module 10 is a central processing unit (CPU), a microprocessor (MCU), or an application-specific integrated circuit (ASIC).

The storage module 14 is a non-volatile memory, and may be a flash memory or a hard disk. The power module 15 is an AC to DC voltage converter or a DC to DC voltage converter.

Referring to FIG. 2, the multifunction wireless module 11 includes a long-distance communication unit 111, a long-distance antenna 111ANT, a first short-distance communication unit 112, a first show-distance antenna 112ANT, and a power supply unit 113.

The long-distance communication unit 111 is electrically connected to the long-distance communication antenna 111ANT. The first short-distance communication unit 112 is electrically connected to the first short-distance 112ANT. In other embodiments, the long-distance communication unit 111 and the long-distance communication antenna 111ANT can be integrated by a system in a package process (SIP) or a system on a chip process (SoC). The short-distance communication unit 112 and the first short-distance communication antenna 112ANT can be integrated by a system in a package process (SIP) or a system on a chip process (SoC).

The long-distance communication unit 111 receives or transmits a plurality of long-distance communication signals having a first communication protocol by the long-distance communication antenna 111ANT. The first short-distance communication unit 112 is electrically connected to the long-distance communication unit 111 and the first short-distance communication antenna 112ANT. The first short-distance communication unit 112 receives or transmits a plurality of first short-distance communication signals having a second communication protocol by the short-distance communication antenna 112ANT.

The long-distance communication unit 111 and the first short-distance 112 respectively include a protocol coding table. When the long-distance communication signals received by the long-distance communication unit 111 are transmitted to the first short-distance communication unit 112, the first short-distance communication unit 112 converts the long-distance communication signals having the first communication protocol into a plurality of first short communication signals having the second communication protocol according to the protocol coding table.

Similarly, when the first short-distance communication signals received by the first short-distance communication unit 112 are transmitted to the long-distance communication unit 111, the long-distance communication unit 111 converts the first short-distance communication signals having the second communication protocol into the long-distance communication signals having the first communication protocol according to the protocol coding table. The protocol coding table is a coding table between the first communication protocol and the second communication protocol.

In the embodiment, the first communication protocol is a 4G, 5G, a LoRa communication protocol, a Sigfox communication protocol, or a NB-IoT communication protocol. The second communication protocol is a Wi-Fi communication protocol, a Bluetooth® communication protocol, or a Wi-SUN communication protocol. In other words, the multifunction wireless communication module of the present disclosure can simultaneously receive and transmit the long-distance communication signals (longer than 1 kilometer), and the long-distance communication signals (shorter than 1 kilometer). The multifunction wireless communication module can also process the conversion between the long-distance communication signals and the short-distance communication signals.

In the embodiment, the multifunction wireless communication module 11 further includes a second short-distance communication unit 114, a second short-distance communication antenna 114ANT, a third short-distance communication unit 115, and a third short-distance communication antenna 115ANT. The second short-distance communication unit 114 and the second short-distance communication unit 114 and the second short-distance communication antenna 114ANT can also be integrated by a system in a package process (SIP) or a system on a chip process (SoC).

The second short-distance communication unit 114 is electrically connected to the long-distance communication unit 111 and the second short-distance communication antenna 114ANT. The second short-distance communication unit 114 receives or transmits a plurality of second short-distance communication signals having the second communication protocol through the second short-distance communication antenna 114ANT. The long-distance communication unit 111 and the second short-distance communication unit 114 respectively include the same protocol coding table. When the long-distance communication signals received by the long-distance communication unit 111 are transmitted to the second short-distance communication unit 114, the second short-distance communication unit 114 converts the long-distance communication signals having the first communication protocol into the second short-distance communication signals having the second communication protocol according to the protocol coding table. When the second short-distance communication signals received by the second short-distance communication unit 114 are transmitted to the long-distance communication unit 111, the long-distance communication unit 111 converts the second short-distance communication signals having the second communication protocol into the long-distance communication signals having the first communication protocol according to the protocol coding table.

The third short-distance communication unit 115 is electrically connected to the long-distance communication unit 111 and the third short-distance communication antenna 115ANT. The third short-distance communication unit 115 receives or transmits a plurality of third short-distance communication signals having the second communication protocol through the third short-distance communication antenna 115ANT. The long-distance communication unit 111 and the third short-distance communication unit 115 respectively include the same protocol coding table. When the long-distance communication signals received by the long-distance communication unit 111 are transmitted to the third short-distance communication unit 115, the third short-distance communication unit 115 converts the long-distance communication signals having the first communication protocol into the third short-distance communication signals having the second communication protocol according to the protocol coding table. When the third short-distance communication signals received by the third short-distance communication unit 115 are transmitted to the long-distance communication unit 111, the long-distance communication unit 111 converts the third short-distance communication signals having the second communication protocol into the long-distance communication signals having the first communication protocol according to the protocol coding table.

In other words, the first short-distance communication unit 112, the second short-distance communication unit 114, and the third short-distance communication unit 115 are similar communication units. The gateway device 1 can select the first short-distance communication unit 112, the second short-distance communication unit 114, or the third short-distance communication unit for communication in a short distance. In other embodiments, the multifunction communication module 11 can include only the first short-distance communication unit 112, and the multifunction wireless communication module 11 does not include the second short-distance communication unit 114 and the third short-distance communication unit 115. In addition, the multifunction wireless communication module 11 can include the first short-distance communication unit 112 and the second short-distance communication unit 114, and the multifunction wireless communication module 11 does not include the third short-distance communication unit 115.

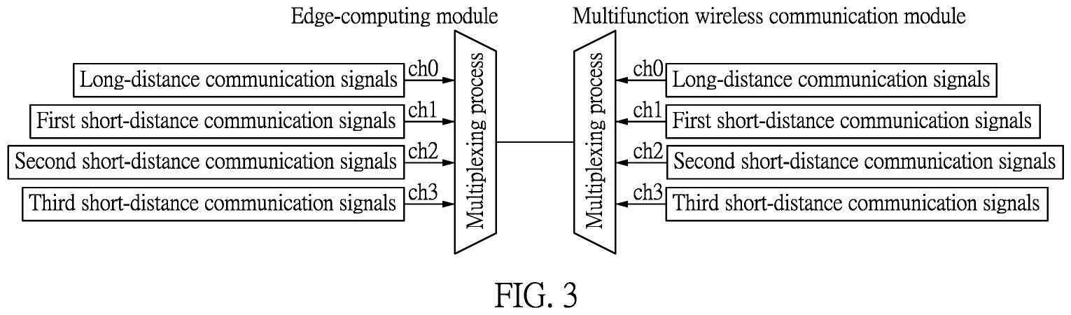

Referring to FIG. 3, FIG. 3 is schematic view showing the multifunction wireless communication module communicating with an edge-computing module.

When signals of the long-distance communication signals of the long-distance communication unit 111, the first short-distance communication signals of the first short-distance communication unit 112, the second short-distance communication signals of the second short communication unit 114, and the third short-distance communication signals of the third short-distance communication unit 115 are needed to be immediately computed by the edge-computing module 12, those signals are directly transmitted to the edge-computing module 12. The communication protocols of the signals directly transmitted to the edge-computing module 12 of the long-distance communication signals, the first short-distance communication signals, the second short-distance communication signals, and the third short-distance communication signals are not changed. When the long-distance communication signals, the first short-distance communication signals, the second short-distance communication signals, and the third short-distance communication signals are calculated by the edge-computing module 12, the computed signals are transmitted to the long-distance communication unit 111, the first short-distance communication unit 112, the second short-distance communication unit 114, and the third short-distance communication unit 115 through respective communication paths ch0-ch4. In the embodiment, the communication paths between the edge-computing module 12 and the long-distance communication unit 111, the first short-distance communication unit 112, the second distance communication unit 114, and the third short-distance communication unit 115 are respectively Universal Asynchronous Receiver/Transmitter interfaces (UART).

The wired communication module 13 is electrically connected to the control module 10. The wired communication module 13 receives a plurality of wired communication signals. The wired communication signals are wirelessly transmitted by the long-distance communication unit 111, the first short-distance communication unit 112, the second short-distance communication unit 114, and the third short-distance communication unit 115 of the multifunction wireless communication module 11.

In addition, the long-distance communication unit 111 determines turn-on states or turn-off states of the first short-distance communication unit 112, the second short-distance communication unit 114, and the third short-distance communication unit 115. Furthermore, the long-distance communication unit 111 determines the turn-on states and the turn-off states of the first short-distance communication unit 112, the second short-distance communication unit 114, and the third short-distance communication unit 115 based on a working state of the multifunction wireless communication module 11.

In the embodiment, the multifunction wireless communication module 11 further includes a first switch 116, a second switch 117, and a third switch 118. The first switch 116 is disposed between the first short-distance communication unit 112 and the power supply unit 113. The second switch 117 is disposed between the second short-distance communication unit 114 and the power supply unit 113. The third switch 118 is disposed between the third short-distance communication unit 115 and the power supply unit 113. The power supply unit 113 provides a first voltage to the first short-distance communication unit 112. The power supply unit 113 provides a second voltage to the second short-distance communication unit 114. The power supply unit 113 provides a third voltage to the third short-distance communication unit 115.

The first switch 116 is electrically connected to the long-distance communication unit 111 to receive a first switch control signal. The second switch 117 is electrically connected to the long-distance communication unit 111 to receive a second switch control signal. The third switch 118 is electrically connected to the long-distance communication unit 111 to receive a third switch control signal. The long-distance communication unit 111 provides a first switch control signal to turn on or turn off the first switch 116 for conducting or blocking the first voltage such that the first short-distance communication unit 112 is turned on or turned off. The long-distance communication unit 111 provides a second switch control signal to turn on or turn off the second switch 117 for conducting or blocking the first voltage such that the second short-distance communication unit 114 is turned on or turned off. The long-distance communication unit 111 provides a third switch control signal to turn on or turn off the second switch 117 for conducting or blocking the first voltage such that the third short-distance communication unit 115 is turned on or turned off. The long-distance communication unit 111 adjusts the turn-on states and the turn-off states of the first short-distance communication unit 112, the second short-distance communication unit 114, and the third short-distance communication unit 115 through the first switch 116, the second switch 117, and the third switch 118 for reducing power consumption.

In the embodiment, the first short-distance communication unit 112 has a first predetermined load. The second short-distance communication unit 114 has a second predetermined load. The third short-distance communication unit 115 has a third predetermined load. The long-distance communication unit 111 determines whether to turn on the second short-distance communication unit 114 and the third short-distance communication unit based on a total load.

In other words, the first short-distance communication unit 112 is predetermined to be turned on for short-distance transmission. However, the turn-on state and the turn-off of the second short-distance communication unit 114 and the third short-distance communication unit 115 are determined by the total load. In the embodiment, the first predetermined load, the second predetermined load, the third predetermined load, and the total load are based on a number of communication connections. For example, when the first short-distance communication unit 112, the second short-distance communication unit 114, and the third short-distance communication unit 115 are Wi-SUN communication units, a number of the first predetermined load, the second predetermined load, and the third predetermined load is 17. In other words, each of the short-distance communication unit can be connected to 17 electronic devices. The total load is a number that the electronic devices transmit to the gateway device for connection requests.

The gateway device 1 can automatically compare the total load and a number of connection capacity of the short-distance communication unit to determine whether the second short-distance communication unit 114 and the third short-distance communication unit 115 are turned on. Two methods are listed in the following paragraphs for determining whether to turn on the second short-distance communication unit 114 and the third short-distance communication unit 115. In the embodiment, the total load, the first predetermined load, the second predetermined load, and the third predetermined load are integers.

Firstly, a first determining method is that when the total load is larger than or equal to a first predetermined load, the long-distance communication unit 111 turns on the second short-distance communication unit 114.

Furthermore, when the total load is larger than or equal to an amount of the first predetermined load and the second predetermined load, the long-distance communication unit 111 turns on the second short-distance communication unit 114 and the third short-distance communication unit 115.

The second method is to turn on other short-distance communication units before the total load is larger than or equal to an amount of predetermined load of the turned-on short-distance communication units. In other words, when the total load is equal to the first predetermined load minus 2, the long-distance communication unit 111 determines to turn on the second short-distance communication unit 114. When the total load is greater than or equal to the amount of the first predetermined load and the second predetermined load minus 2, the long-distance communication unit 111 turns on the second short-distance communication unit 114 and the third short-distance communication unit 115. In other embodiments, a threshold value that the first predetermined load reduced by 1 or 3 can be used for turning on the second short-distance communication unit 114, and is not limited to the present disclosure.

The power module 15 of the gateway 1 respectively provides the driving energy to the multifunction wireless communication module 11, the edge-computing module 12, the control module 10, and the wired communication module 13. The power module 15 is electrically connected to the power supply unit 113 to supply a reference voltage to the power supply unit 113. The power supply unit 113 converts the reference voltage into a first voltage, a second voltage, and a third voltage.

In conclusion, the gateway device of the present disclosure can convert the communication protocol by the long-distance communication unit and the short-distance communication units in the multifunction wireless communication module, which greatly reduces a workload of the control module. In addition, the gateway device of the present disclosure can also adjust the connection capacity by turning on or turning off the short-distance communication units, which greatly improves the adaptability for various working states.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A gateway device comprising:
a multifunction wireless communication module, including:
a long-distance communication unit being electrically connected to a long-distance communication antenna, the long-distance communication unit transmitting or receiving a plurality of long-distance communication signals having a first communication protocol; and a first short-distance communication unit being electrically connected to the long-distance communication unit and a first short-distance communication antenna, the first short-distance communication unit transmitting or receiving a plurality of short-distance communication signals having a second communication protocol through the first short-distance communication antenna, the long-distance communication unit and the first short-distance communication unit respectively including a protocol coding table, wherein when the long-distance communication signals received by the long-distance communication unit are transmitted to the first short-distance communication unit, the first short-distance communication unit converts the long-distance communication signals having the first communication protocol into the short-distance communication signals having the second communication protocol according to the protocol coding table, and when the short-distance communication signals received by the first short-distance communication unit are transmitted to the long-distance communication unit, the long-distance communication unit converts the short-distance communication signals having the second communication protocol into the long-distance communication signals having the first communication protocol according to the protocol coding table, the protocol coding table being a coding table between the first communication protocol and the second communication protocol;
an edge-computing module being electrically connected to the multifunction wireless communication module, signals needed to be immediately computed by the edge-computing module of the long-distance communication signals of the long-distance communication unit and the short-distance communication signals of the first short-distance communication unit are directly transmitted to the edge-computing module through communication paths, communication protocols of the signals transmitted to the edge-computing module are not changed, and the long-distance communication signals and the short-distance communication signals computed by the edge-computing module are transmitted to the long-distance communication unit and the first short-distance communication unit for communication;
a control module electrically connected to the multifunction wireless communication module; and
a wired communication module electrically connected to the control module, the wired communication module receiving a plurality of wired communication signals, and the wired communication signals being wirelessly transmitted by the long-distance communication unit or the first short-distance communication unit of the multifunction wireless communication module.

2. The gateway device of claim 1, wherein the multifunction wireless communication module further includes:
a second short-distance communication unit electrically connected to the long-distance communication unit and a second short-distance communication antenna, the second short-distance communication unit transmitting or receiving a plurality of short-distance communication signals having a second communication protocol through the second short-distance communication antenna, and the long-distance communication unit and the first short-distance communication unit respectively including the protocol coding table;
wherein when the long-distance communication signals received by the long-distance communication unit are transmitted to the second short-distance communication unit, the second short-distance communication unit converts the long-distance communication signals having the first communication protocol into the short-distance communication signals having the second communication protocol according to the protocol coding table, and when the short-distance communication signals received by the second short-distance communication unit are transmitted to the long-distance communication unit, the long-distance communication unit converts the short-distance communication signals having the second communication protocol into the long-distance communication signals having the first communication protocol according to the protocol coding table.

3. The gateway device of claim 2, wherein the multifunction wireless communication module further includes:
a third short-distance communication unit electrically connected to the long-distance communication unit and a third short-distance communication antenna, the third short-distance communication unit transmitting or receiving a plurality of short-distance communication signals having a second communication protocol through the third short-distance communication antenna, and the long-distance communication unit and the third short-distance communication unit respectively including the protocol coding table;
wherein when the long-distance communication signals received by the long-distance communication unit are transmitted to the third short-distance communication unit, the third short-distance communication unit converts the long-distance communication signals having the first communication protocol into the short-distance communication signals having the second communication protocol according to the protocol coding table, and when the short-distance communication signals received by the second short-distance communication unit are transmitted to the long-distance communication unit, the long-distance communication unit converts the short-distance communication signals having the second communication protocol into the long-distance communication signals having the first communication protocol according to the protocol coding table.

4. The gateway device of claim 2, wherein the long-distance communication unit determines turn-on states and turn-off states of the first short-distance communication unit, the second short-distance communication unit, and the third short-distance communication unit.

5. The gateway device of claim 3, wherein the multifunction wireless communication module further includes a first switch, a second switch, a third switch, and a power supply unit, the first switch being disposed between the first short-distance communication unit and the power supply unit, the second switch being disposed between the second short-distance communication unit and the power supply unit, the third switch being disposed between the third short-distance communication unit and the power supply unit, the power supply unit providing a first voltage to the first short-distance communication unit, the power supply unit providing a second voltage to the second short-distance communication unit, and the power supply unit providing a third voltage to the third short-distance communication unit.

6. The gateway device of claim 5, wherein the first switch is electrically connected to the long-distance communication unit to receive a first switch control signal, the second switch is electrically connected to the long-distance communication unit to receive a second switch control signal, the third switch is electrically connected to the long-distance communication unit to receive a third switch control signal, the long-distance communication unit provides the first switch control signal to turn on or turn off the first switch for conducting or blocking the first voltage such that the first short communication unit is turned on or turned off, the long-distance communication unit provides the second switch control signal to turn on or turn off the second switch for conducting or blocking the second voltage such that the second short communication unit is turned on or turned off, and the long-distance communication unit provides the third switch control signal to turn on or turn off the third switch for conducting or blocking the third voltage such that the third short communication unit is turned on or turned off.

7. The gateway device of claim 5, further comprising a power module, the power module provides driving power to the multifunction wireless communication module, the edge-computing module, the control module, and the wired communication module, wherein the power module is electrically connected to the power supply unit to provide a reference voltage to the power supply unit, and the power supply unit converts the reference voltage into the first voltage, the second voltage, and the third voltage.
